(19) United States
(12) Patent Application Publication
(10) Pub. No.: US 2026/0249242 A1
(43) Pub. Date: Aug. 27, 2026

(54) CARBON SEQUESTRATION

(71) Applicants: Darryl Tony JONES, Wickford (Essex) (GB); Oxford University Innovation Limited, Oxford (GB)

(72) Inventors: Darryl Tony JONES, Wickford (Essex) (GB); Barbara ROSSI, Oxford (GB)

(21) Appl. No.: 19/162,243

(22) PCT Filed: Mar. 13, 2024
(86) PCT No.: PCT/GB2024/050672

§ 371 Date: Sep. 4, 2025

(30) Foreign Application Priority Data
Mar. 14, 2023 (GB) 2303713.8

(51) Int. Cl. B01D 53/85; A01G 9/24; A01G 22/30; B01D 53/62

(52) U.S. Cl. CPC B01D 53/85; A01G 9/247; A01G 22/30; B01D 53/62; B01D 2257/504

(57) ABSTRACT

A carbon sequestration unit (1) comprises a support layer (10) configured to support a photosynthetic organism (12), a growth substrate (14) for the photosynthetic organism disposed along the support layer, and an irrigation pipe (16) configured to release water along its length for irrigating the photosynthetic organism. The support layer has a shape that is convoluted in three dimensions allowing for growth surface maximisation compared to the land on which the carbon sequestration unit is deployed.

The present invention relates to carbon sequestration.

Global warming is a significant concern, due to the impact on climate. Carbon dioxide (CO₂), along with other “greenhouse gases” is a major contributor to global warming due to causing the absorption of infrared radiation released by the Earth from solar heating on a planetary scale.

With each passing year, more CO₂ is released into the atmosphere than the natural carbon cycle process can remove, causing atmospheric levels of CO₂ to increase by significant amounts. The scale of the problem is immense as illustrated by the following. The global average CO₂ set a then record high in 2021 of 414.72 parts per million and subsequently CO₂ measurements peaked for 2022 during May at 420.99 parts per million. Emissions growth during 2020 tied for the fifth-largest one-year increase in the 63-year record. The annual rate of increase in atmospheric CO₂ over the past 60 years is about 100 times faster than previous natural increases, such as those that occurred at the end of the last ice age 11,000-17,000 years ago. The ocean has absorbed enough CO₂ to lower its pH by 0.1 units, a 30% increase in acidity.

To tackle global warming, there exist initiatives to reduce the amount of CO₂ in the atmosphere. Many such initiatives relate to reducing the emission of CO₂, but financial shortfalls create doubt that the world can build the necessary green energy infrastructure to be able to transition away from its reliance on fossil fuels in the available timeframe.

Accordingly, there is a need for initiatives relating to carbon sequestration whilst renewable energy infrastructure is developed. Carbon sequestration involves the removal of CO₂ from the atmosphere by capture of the CO₂ and conversion into a carbon-containing product that is stored to prevent re-release of the CO₂. However, given physical and financial resource constraints, carbon sequestration is challenging on the planetary scale that is required, involving hundreds of gigatonnes of carbon (GtC). Some considerations are as follows.

Many carbon sequestration approaches are nature-based and use the basic carbon capture efficiency of plants.

Trees are natural carbon sinks and can sequester large amounts of carbon from the atmosphere for photosynthesis, using solar energy to turn this into sugar and oxygen.

Planting or replanting of forests therefore has been posited as a way to offset human-driven CO₂ emissions. One estimate is that planting 1 trillion trees has the potential to capture up to almost 750 GtC from the atmosphere. In addition, trees are often regarded as the cheapest CO₂ sequestration solution. There are however issues with this approach. It would take decades for this many trees to mature and achieve this potential. By way of example, if a typical tree absorbs an average of 10 kilograms, or 22 pounds, of carbon dioxide per year for the first 20 years then for 1 T (trillion) trees planted, 10 GtC would be removed from the atmosphere per year for the first 20 years. With atmospheric CO₂ concentration continuing to rise and unlikely to abate significantly in the near-term, planting 1 T trees will be unlikely to be enough to offset human-driven greenhouse gas emissions to the extent that global warming stays below 1.5° C.

Carbon sequestration has also been considered using photosynthetic organisms having a smaller scale than trees, for example mosses. Moss possesses properties that make it an exceptional performer when it comes to sequestering CO₂. Moss grows prolifically in peatlands, which store twice as much carbon as all the world's forests despite only covering 3% of land on Earth (compared to 37% of habitable land coverage by forests). This is driven by the fact that the surface area of moss can be up to 30 times larger than that of a smooth surface occupying the same space, enabling efficient photosynthesis, resulting in the ability to absorb of the order of 1 kg of CO₂ per 0.5 m². Certain pleurocarp mosses also absorb up to 20 times their own weight in water which illustrates their propensity to flourish in moist conditions. Because pleurocarp mosses constantly utilise moisture and continue branching out indefinitely, they can double their size in six months in optimal environmental conditions.

Moss is a sustainable and natural resource that can be grown easily and freely, but its ability to sequester carbon is still too low compared to global emissions of CO₂ per annum and a limiting factor for large-scale growth of moss is the amount of available land that provides ideal conditions conducive for its proliferation.

Accordingly, to exploit the properties of moss or other photosynthetic organisms in carbon sequestration, it is desirable to find a technical solution that provides optimal conditions to promote sustainable growth and is scalable in a manner that overcomes the limiting physical constraint of available habitable land. The present invention relates to such technical solutions.

According to a first aspect of the invention, there is provided a carbon sequestration unit comprising: a support layer configured to support one or more photosynthetic organism. Such a carbon sequestration unit may be used to support a photosynthetic organism in a manner that promotes growth and is scalable.

Typically, the support layer may have apertures. This facilitates the supply of water, air and/or light to the supported one or more photosynthetic organism. In one example, the support layer may be a mesh, optionally a woven mesh.

Typically, the support layer is in the form of a sheet.

In some types of carbon sequestration unit, the carbon sequestration unit may further comprise an irrigation pipe configured to release water along its length for irrigating the one or more photosynthetic organism, the irrigation pipe extending along the support layer. This combination provides a convenient way to optimise the irrigation of all the supported one or more photosynthetic organism.

The irrigation pipe may be anchored to the support layer. This improves the structural integrity of the carbon sequestration unit.

In such a case, the support layer may be curved and extends at least partly around the irrigation pipe, optionally being tubular and extending around the irrigation pipe.

The support layer may have apertures and be configured to support the one or more photosynthetic organism on a side opposite from the irrigation pipe. In this case the apertures are configured to allow the passage of water from the irrigation pipe to the one or more photosynthetic organism. Such a support layer optimises the irrigation of the supported one or more photosynthetic organism.

The support layer may have apertures and be configured to support the one or more photosynthetic organism on the same side as the irrigation pipe. In this case the apertures are configured to allow the passage of light to the one or more photosynthetic organism.

The support layer may have apertures that are configured to allow the one or more photosynthetic organism to penetrate the support layer. In this case, the support layer is configured to support the one or more photosynthetic organism on both sides thereof.

The support layer may have a shape that is convoluted in three dimensions. This permits growth surface maximisation, that is maximisation of the surface area of the support layer, and hence the photosynthetic organism supported thereby, relative to a given overall volume of the carbon sequestration unit or relative to a given area of land on which the carbon sequestration unit is deployed. This effectively overcomes the limiting physical constraint of available space by densifying the photosynthetic organism, leading to a material multiplication factor of the carbon sequestration.

In some types of carbon sequestration unit, the support layer may be elongate.

As an example, the support layer may have a tubular form and be elongate along a tubular axis thereof. Such a configuration maximises the effective surface area and volumetric space for growth and also provides a robust and rigid structure.

The support layer may have a shape along its length that is convoluted in three dimensions. This is a convenient way to provide growth surface maximisation.

The shape may be a helical shape, optionally a regular helical shape. Using helical geometries provides growth surface maximisation in a similar manner to the use of helical geometries in heat exchangers to optimise their thermal performance.

In other types of carbon sequestration unit, the support layer may have an undulating shape so that its surface area is greater than a projected area onto a plane across which the support layer extends. This is a convenient way to provide growth surface maximisation compared to the projected area, which may correspond to an area of land over which the carbon sequestration unit is deployed, while still allowing access to light and water.

In some applications, water may be supplied to the photosynthetic organism by exposing the carbon sequestration unit to natural precipitation. As an alternative, the carbon sequestration unit may further comprise an irrigation system for irrigating the one or more photosynthetic organism. Such an irrigation system may be used to increase and control the supply of water to optimise growth of the photosynthetic organism. Such an irrigation system may, for example, comprise one or more irrigation pipe configured to release water along its length, for example as follows.

Advantageously, the support layer may have sufficient rigidity when wet to maintain its shape. Given the need to supply water to the supported one or more photosynthetic organism, this improves the structural integrity of the carbon sequestration unit.

The support layer may be made of metal or is made of a compostable material.

In use, a growth substrate for the one or more photosynthetic organism may be disposed along the support layer. In the case of using an irrigation pipe, such a substrate is arranged to receive water released from the irrigation pipe for supply to the one of more photosynthetic organism.

In use, one or more photosynthetic organism is supported on the support layer. In general any suitable photosynthetic organism may be supported. Some specific examples are given below.

According to a second aspect of the present invention, there is provided a carbon sequestration module comprising plural carbon sequestration units according to the first aspect of the present invention. This provides a convenient way to scale up the carbon sequestration units by incorporating them into a carbon sequestration module. The carbon sequestration units may include any of the features described above.

In one type of carbon sequestration module: in the carbon sequestration units, the support layer is elongate and has a shape along its length that is a helical shape; and the carbon sequestration units are arranged with helical axes of the helical shapes arrayed to extend in a common plane so that the carbon sequestration module form a panel.

In another type of carbon sequestration module: in the carbon sequestration units, the support layer is elongate and has a shape along its length that is a helical shape; and the carbon sequestration units are arranged with the helical axes of the helical shapes arrayed in two dimensions orthogonal to the helical axes so that the carbon sequestration module forms a block.

According to a third aspect of the present invention, there is provided a carbon sequestration device comprising plural carbon sequestration modules according to the second aspect of the present invention. This provides a convenient way to scale up the carbon sequestration modules by incorporating them into a carbon sequestration device. The carbon sequestration modules may include any of the features described above.

In one advantageous form, the carbon sequestration modules may have a shape that tessellates in two dimensions or in three dimensions. In this case, the carbon sequestration modules may be tessellated in two dimensions or in three dimensions in the carbon sequestration device, so that they fully fill an area or a volume. This permits growth surface maximisation, that is maximisation of the surface area of the support layer, and hence the photosynthetic organism supported thereby, relative to a given area of land on which the carbon sequestration unit is deployed. This effectively overcomes the limiting physical constraint of available space by densifying the photosynthetic organism, leading to a material multiplication factor of the carbon sequestration.

In another advantageous form of the carbon sequestration device, the carbon sequestration modules are carbon sequestration modules that form a panel, for example as described above, and the carbon sequestration modules are arranged to form faces of a polyhedron. This permits growth surface maximisation, that is maximisation of the surface area of the support layer, and hence the photosynthetic organism supported thereby, relative to a given area of land on which the carbon sequestration unit is deployed. This effectively overcomes the limiting physical constraint of available space by densifying the photosynthetic organism, leading to a material multiplication factor of the carbon sequestration. At the same time, the polyhedron form provides space within the polyhedron for aeration of the one or more photosynthetic organism.

According to a fourth aspect of the present invention, there is provided a method of sequestering carbon comprising growing an organism on a carbon sequestration unit according to the first aspect of the present invention, a carbon sequestration module according to the second aspect of the present invention, or a carbon sequestration device according to the third aspect of the present invention. The carbon sequestration unit, module or device may include any of the features described above. Such a method allows carbon to sequestered in the carbon sequestration unit, module or device.

The method may further comprise harvesting the organism. This allows the harvested organism to be stored or used without releasing CO₂.

In that case, the method may further comprise burying the harvested organism or pyrolysing the harvested organism to produce a product for disposal or use.

Embodiments of the invention will now be described, by way of non-limitative example, with reference to the accompanying drawings in which:

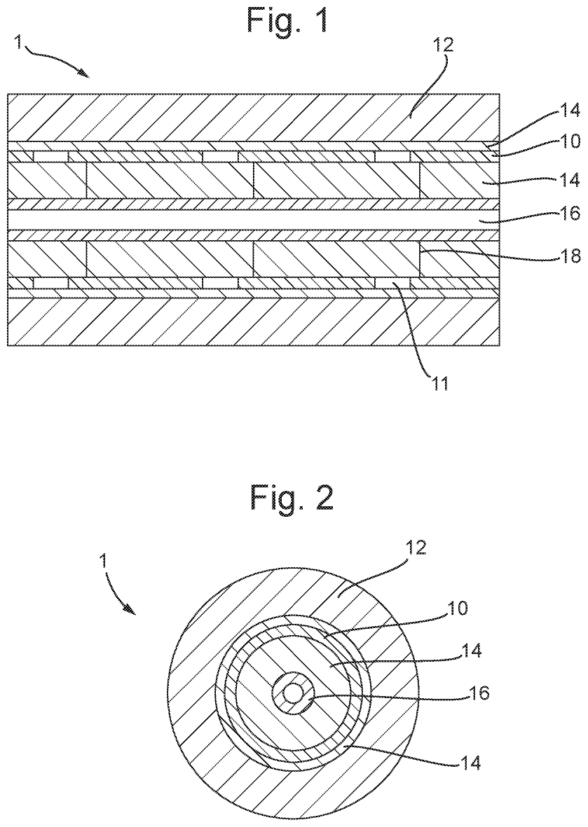

FIG. 1 is a schematic cross-sectional view of a portion of a carbon sequestration unit having a tubular construction of a first type, taken along a tubular axis of the tubular construction;

FIG. 2 is a schematic cross-sectional view of a portion of the carbon sequestration unit of FIG. 1, taken orthogonal to the tubular axis;

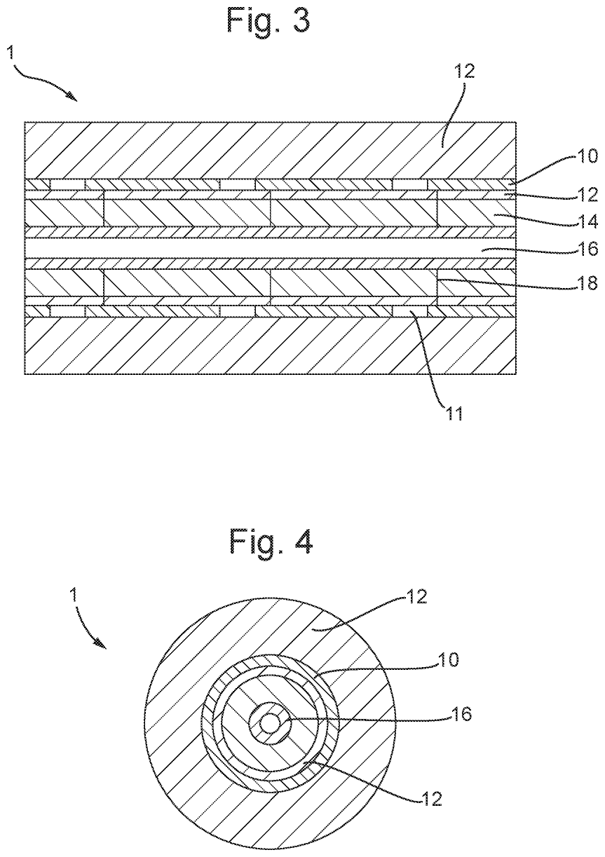

FIG. 3 is a schematic cross-sectional view of a portion of a carbon sequestration unit having a tubular construction of a second type, taken along a tubular axis of the tubular construction;

FIG. 4 is a schematic cross-sectional view of a portion of the carbon sequestration unit of FIG. 3, taken orthogonal to the tubular axis;

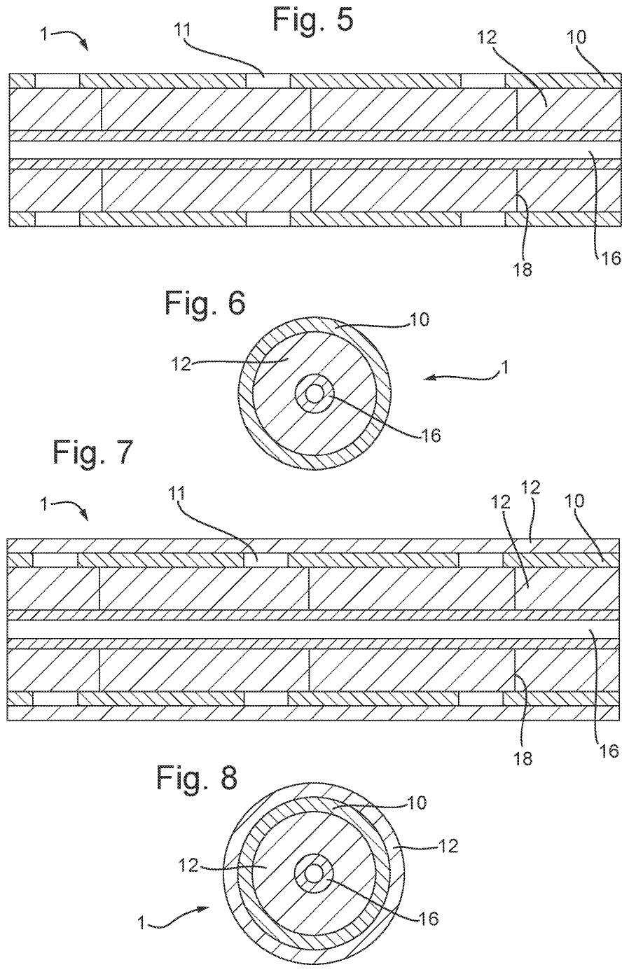

FIG. 5 is a schematic cross-sectional view of a portion of a carbon sequestration unit having a tubular construction of a third type, taken along a tubular axis of the tubular construction;

FIG. 6 is a schematic cross-sectional view of a portion of the carbon sequestration unit of FIG. 5, taken orthogonal to the tubular axis;

FIG. 7 is a schematic cross-sectional view of a portion of a carbon sequestration unit having a tubular construction of a fourth type, taken along a tubular axis of the tubular construction;

FIG. 8 is a schematic cross-sectional view of a portion of the carbon sequestration unit of FIG. 7, taken orthogonal to the tubular axis;

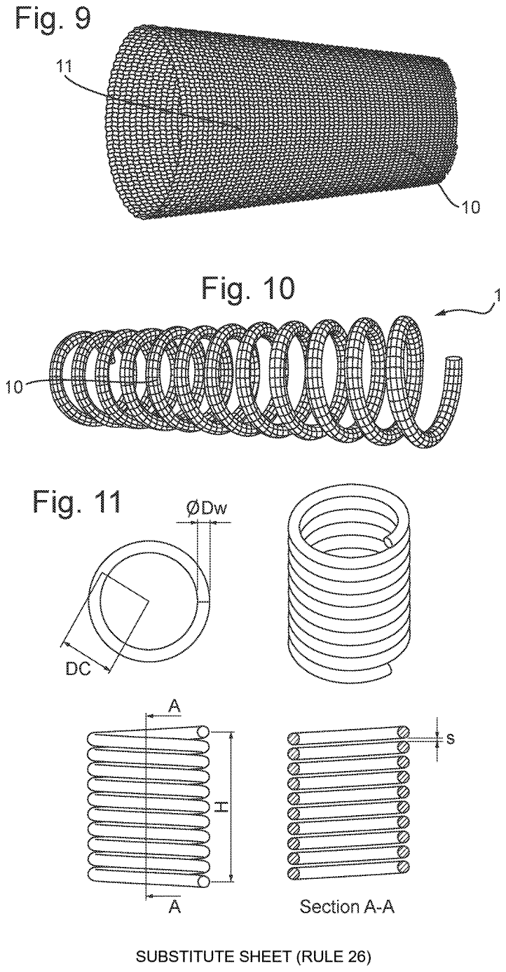

FIG. 9 is a perspective view of an example of a support layer made of woven mesh;

FIG. 10 is a perspective view of a carbon sequestration unit having the tubular construction of any of FIG. 1, 3, 5 or 7 and having a helical shape along its length;

FIG. 11 is a set of views of a carbon sequestration unit having the tubular construction of any of FIG. 1, 3, 5 or 7 and having a helical shape along its length, showing dimensional characteristics of the helical shape.

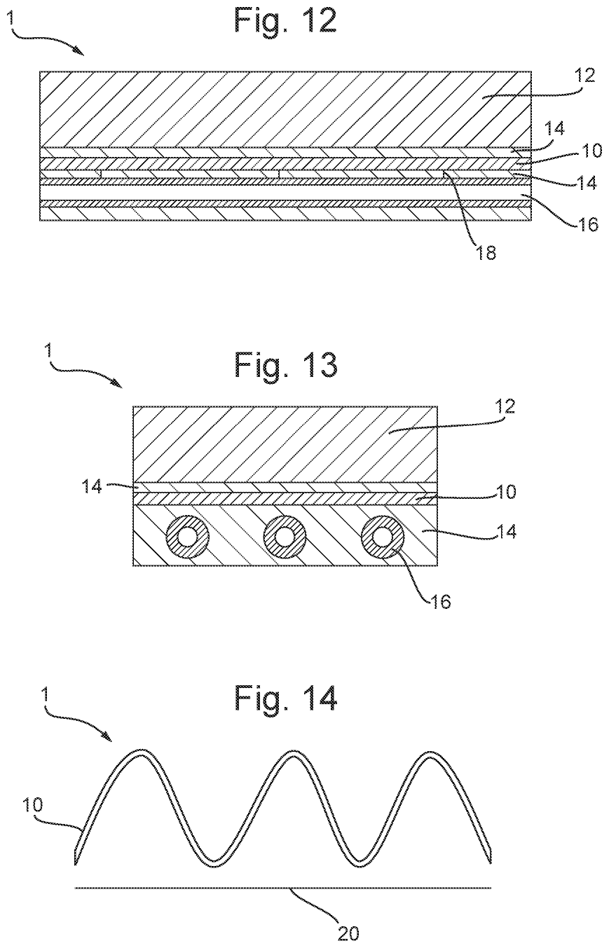

FIG. 12 is a schematic cross-sectional view of a portion of a carbon sequestration unit having a planar construction, taken along a first axis;

FIG. 13 is a schematic cross-sectional view of a portion of the carbon sequestration unit of FIG. 12, taken orthogonal to the first axis of the tubular construction;

FIG. 14 is a view of a carbon sequestration unit having the planar construction of FIGS. 12 and 13 and having an undulating shape;

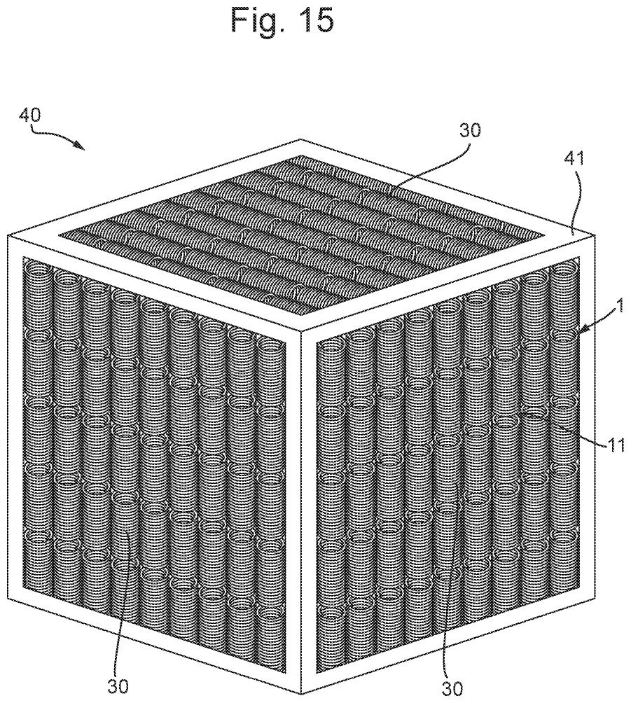

FIGS. 15 to 21 are perspective views of different forms of a carbon sequestration device formed by an arrangement of carbon sequestration modules themselves formed by an array of carbon sequestration units as shown in FIG. 10;

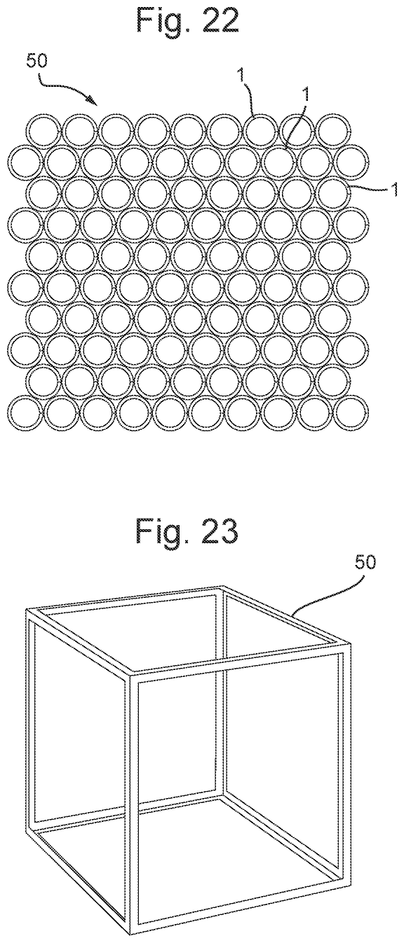

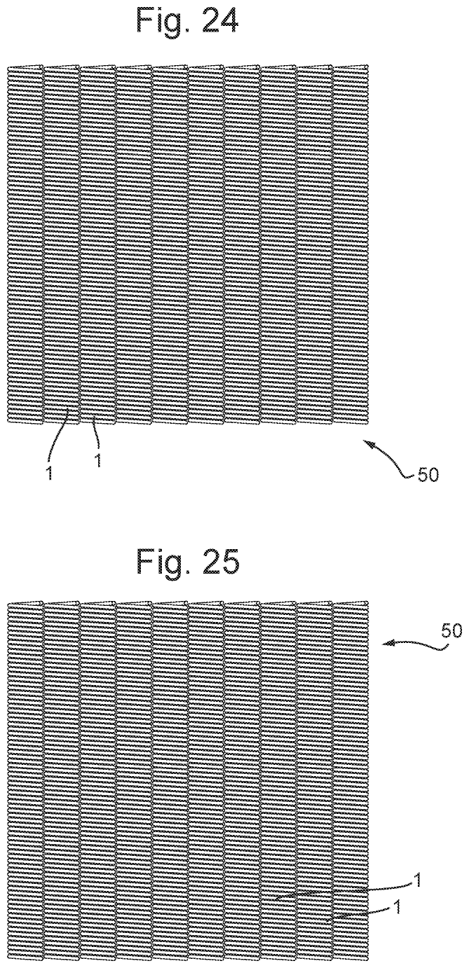

FIGS. 22 to 25 are a top view, a perspective view, and two side views, respectively of a carbon sequestration module formed by an array of carbon sequestration units as shown in FIG. 10;

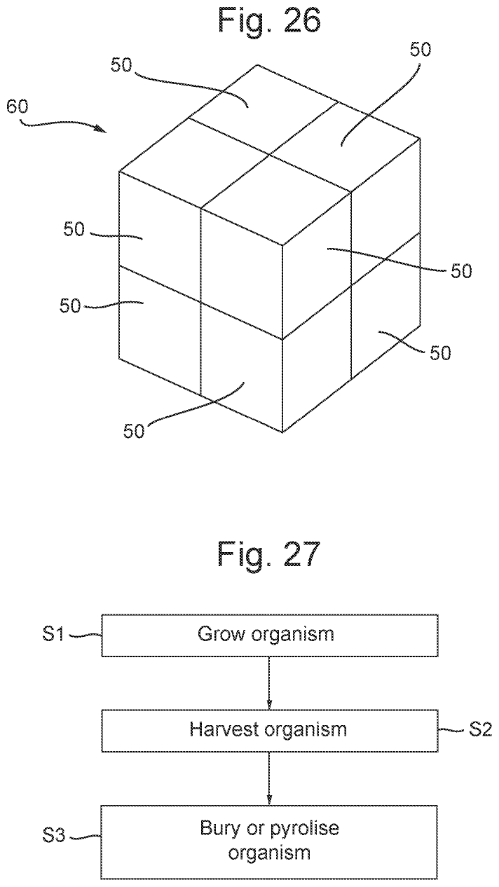

FIG. 26 is a perspective view of a carbon sequestration device formed by an arrangement of carbon sequestration modules as shown in FIGS. 22 to 25; and

FIG. 27 is a flow chart of a method of using the carbon sequestration units, modules or devices described herein.

FIGS. 1 to 8 show examples of a portion of a carbon sequestration unit 1 in which the carbon sequestration unit 1 has tubular constructions of four different types. In FIGS. 1, 3, 5 and 7, the cross-sections are taken along an axis along which the carbon sequestration unit 1 extends, albeit that, for clarity in showing the internal construction, the portion is short and does not show any shape along its length. In FIGS. 2, 4, 6 and 8, the cross-sections are taken across the axis along which the carbon sequestration unit 1 extends. In each of the four types of tubular construction, common elements are given common reference numerals and the same description applies, except for the differences identified below.

FIGS. 1 and 2 show an example of a portion of a carbon sequestration unit 1 in which the carbon sequestration unit 1 has a tubular construction of a first type. The carbon sequestration unit 1 is arranged as follows.

The carbon sequestration unit 1 comprises a support layer 10. The support layer 10 is configured to support one or more photosynthetic organism 12 as follows. The support layer 10 is a sheet and has apertures 11, i.e. is porous. The construction of the support layer 10 itself is described below.

In the example of FIGS. 1 and 2, the support layer 10 has a tubular form and is elongate along a tubular axis thereof, having a greater length along the tubular axis than diameter across the tubular axis, typically by a significant degree noting that only a portion of the carbon sequestration unit 1 is shown in FIG. 1. The support layer 10 is shown as having a circular cross-sectional shape but this is not limitative and general may have any cross-sectional shape, including without limitation a square shape, a polygonal shape, or an irregular shape.

The one or more photosynthetic organism 12 is supported on the outside of the support layer 10 and so also has a tubular form.

The carbon sequestration unit 1 also includes a growth substrate 14 for the one or more photosynthetic organism 12. The growth substrate 14 is disposed along the support layer 10 and supported thereon. In FIGS. 1 and 2, the growth substrate 14 is shown as being located on both sides of the support layer 10, but alternatively the growth substrate 14 may be provided on only the outer side or only on the inner side of the support layer 10. In the latter case, the growth substrate 14 may extend to the inner surface of the support layer 10, or may fill apertures 11 in the support layer 10 so that the growth substrate extends to the outer surface of the support layer 10.

The growth substrate 14 is a substrate on which the one or more photosynthetic organism 12 grows. The one or more photosynthetic organism 12 may grow on the surface of the growth substrate 14 or may have roots extending into the growth substrate 14 and anchoring the one or more photosynthetic organism 12 thereto. Where the growth substrate 14 is provided only on the inner side of the support layer 10, the one or more photosynthetic organism 12 may grow on the support layer 10 alone when the apertures 11 of the support layer 10 are relatively small. Alternatively, where the growth substrate 14 is provided only on the inner side of the support layer 10, the one or more photosynthetic organism 12 may grow both on the support layer 10 and on the growth substrate 14 when the apertures 11 of the support layer 10 are sufficiently large that the growth substrate 14 presents itself between them. Where the growth substrate 14 fills the inner side of support layer 10 and the apertures 11, the one or more photosynthetic organism 12 may grow on the smooth and contiguous surface formed by support layer 10 and growth substrate 14 along the length of the tubular construction.

The growth substrate 14 supplies water to the one or more photosynthetic organism 12. The water may be provided by an irrigation system, for example in the form of an irrigation pipe 16 described below, or may be provided by natural precipitation where no irrigation system is provided. The growth substrate 14 may also provide nutrients to the one or more photosynthetic organism 12.

The growth substrate 14 may have any suitable properties, including composition, density and porosity. The composition may be a typical composition for horticultural use. The growth substrate 14 may be selected to optimise the growth of one or more photosynthetic organism 12. Therefore, the composition may depend on the nature of the one or more photosynthetic organism 12, which is further described below. In a particular non-limitative example, the growth substrate 14 may be a compacted, clay-like soil.

The carbon sequestration unit 1 also includes an irrigation pipe 16 which acts as an irrigation system for supplying water to the one or more photosynthetic organism 12. The irrigation pipe 16 is configured to release water along its length and may be of a suitable construction to achieve that, for example having apertures dispersed along its length or being made of a porous material.

The irrigation pipe 16 is located inside the tubular form of the support layer 10 and therefore extends along the length of the support layer 10. Thus, the irrigation pipe 16 extends through the growth substrate 14 and is in contact with the growth substrate 14, although as an alternative a gap or intermediate porous layer could be provided.

The irrigation pipe 16 is anchored to the support layer 10, by spurs 18 extending therebetween. Such anchoring improves the structural integrity of the carbon sequestration unit 10. Alternatively, anchoring may be provided any other mechanical structure, or may be omitted, relying instead on the growth substrate 14 to hold the irrigation pipe 16 in place within the support layer 10.

As the irrigation pipe 16 extends along the length of the support layer 10, water is similarly supplied to the growth substrate 14 and one or more photosynthetic organism 12 along the entire length of the carbon sequestration unit 1, thereby optimising the irrigation of all of the one or more photosynthetic organism 12.

As result of its tubular form, the support layer 10 is curved and extends entirely around the irrigation pipe 16. Thus, water is supplied to the one or more photosynthetic organism 12, all around the support layer 10, passing through the growth substrate 14 and through the apertures 11 in the support layer 10, as a result of the one or more photosynthetic organism being supported outside the support layer 10, that is on a side of the support layer 10 opposite from the irrigation pipe 16.

FIGS. 3 and 4 show an example of a portion of a carbon sequestration unit 1 in which the carbon sequestration unit 1 has a tubular construction of a second type. This is identical to the tubular construction of the first type shown in FIGS. 1 and 2, except that the growth substrate 14 on which the one or more photosynthetic organism 12 grows is located only on the inner side of the support layer 10. As such, part of the photosynthetic organism 12 is inside the support layer 10, and the photosynthetic organism 12 extends through the apertures in the support layer 10. In this case, water and nutrients to support the growth of the photosynthetic organism 12 is passed between parts of the photosynthetic organism 12 by internal transport. If this does not meet all the growth needs of the photosynthetic organism 12, the apertures 11 may also pass some of the water or light needed to support the growth of the photosynthetic organism 12. Air for the parts of the photosynthetic organism 12 inside the support layer 10 also passes through the apertures 11.

FIGS. 5 and 6 show an example of a portion of a carbon sequestration unit 1 in which the carbon sequestration unit 1 has a tubular construction of a third type. The carbon sequestration unit 1 is arranged as follows.

In the tubular construction of the third type, the carbon sequestration unit 1 has a support layer 10 and an irrigation pipe 16 that are the same as in the tubular constructions of the first and second types shown in FIGS. 1 to 4, but the growth substrate 14 is absent and the one or more photosynthetic organism 12 is supported by the support layer 10 inside the support layer 10, as will now be described in more detail.

The support layer 10 is a sheet and has apertures 11, i.e. is porous. The construction of the support layer 10 itself is described below.

In the example of FIGS. 5 and 6, the support layer 10 has a tubular form and is elongate along a tubular axis thereof, having a greater length along the tubular axis than diameter across the tubular axis, typically by a significant degree noting that only a portion of the carbon sequestration unit 1 is shown in FIG. 5. The support layer 10 is shown as having a circular cross-sectional shape but this is not limitative and general may have any cross-sectional shape, including without limitation a square shape, a polygonal shape, or an irregular shape.

The one or more photosynthetic organism 12 is supported on the inside of the support layer 10.

The carbon sequestration unit 1 also includes an irrigation pipe 16 which acts as an irrigation system for supplying water directly to the one or more photosynthetic organism 12 because it is inside the support layer 10 and so on the same side of the support layer 10 as the irrigation pipe. The irrigation pipe 16 is configured to release water along its length and may be of a suitable construction to achieve that, for example having apertures dispersed along its length or being made of a porous material.

The irrigation pipe 16 is located inside the tubular form of the support layer 10 and therefore extends along the length of the support layer 10. Thus, the irrigation pipe 16 extends through the photosynthetic organism 12 and is in contact with the growth substrate 14, although as an alternative a gap or intermediate porous layer could be provided.

The irrigation pipe 16 is anchored to the support layer 10, by spurs 18 extending therebetween. Such anchoring improves the structural integrity of the carbon sequestration unit 10. Alternatively, anchoring may be provided any other mechanical structure, or may be omitted, relying instead on the photosynthetic organism 12 to hold the irrigation pipe 16 in place within the support layer 10.

As the irrigation pipe 16 extends along the length of the support layer 10, water is similarly supplied to the one or more photosynthetic organism 12 along the entire length of the carbon sequestration unit 1, thereby optimising the irrigation of all of the one or more photosynthetic organism 12.

As result of its tubular form, the support layer 10 is curved and extends entirely around the irrigation pipe 16. Thus, water is supplied to the one or more photosynthetic organism 12, all around the support layer 10, through the growth substrate 14 and through the support layer 10 as a result of the one or more photosynthetic organism being supported on a side of the support layer 10 opposite from the irrigation pipe 16.

As an alternative, water may be provided to the photosynthetic organism 12 by an irrigation system of a different form from the irrigation pipe 16, or may be provided by natural precipitation where no irrigation system is provided.

In the tubular construction of the third type, the one or more photosynthetic organism 12 is supported inside the support layer 10 entirely inside the support layer 10. In this case, light needed to support the growth of the photosynthetic organism 12 is passed through the apertures 11 in the support layer 10. In some cases, the size of the apertures 11 is selected to be sufficiently small to prevent penetration of the support layer 10 by the photosynthetic organism 12, which is thereby retained entirely inside the support layer 10. Air for the photosynthetic organism 12 inside the support layer 10 also passes through the apertures 11.

As an alternative, the size of the apertures 11 may be selected to allow the photosynthetic organism 12 to penetrate the support layer 10 so that part of the photosynthetic organism 12 extends outside the support layer 10. By way of example, FIGS. 7 and 8 show a portion of a carbon sequestration unit 1 in which the carbon sequestration unit 1 has a tubular construction of a fourth type which is identical to that of the third type except that part of the photosynthetic organism 12 has penetrated the support layer 10 to be outside the support layer 10. In this case, water and nutrients to support the growth of the photosynthetic organism 12 is passed between parts of the photosynthetic organism 12 on opposite sides of the support layer 10 by internal transport. If this does not meet all the growth needs of the photosynthetic organism 12, the apertures 11 may also pass some of the water, air and/or light needed to support the growth of the photosynthetic organism 12.

The support layer 10 in all the carbon sequestration unit 1 of all types described herein is designed taking the following considerations into account. The support layer 10 is a three-dimensional structure extending around the internal irrigation pipe 10 acting as the structure that inhabits an available volumetric space to support the growth of the photosynthetic organism 12 in that volumetric space where such and other photosynthetic organisms would not otherwise grow. The support layer 10 may have any suitable construction to provide the function of supporting the one or more photosynthetic organism 12, and the growth substrate 14, if provided, with regard to allowing the structure to be populated densely alongside other structures of its type.

The support layer 10 is a sheet and has sufficient structural integrity to maintain the mechanical structure of the carbon sequestration unit 1 as whole. Account needs to be taken of the overall weight which can become high as the size increases to a suitable scale for carbon sequestration, in particular with types of photosynthetic organism 12 that hold a high degree of water, such as a moss. The support layer 10 supports the propagation and growth of photosynthetic organism 12, either externally of its external surface area (for example in a tubular construction of the first, second or fourth type) and/or internally within its tubular form (for example in a tubular construction of the third or fourth type)).

The support layer 10 has apertures 11, i.e. is porous for the purpose of allowing growth of the photosynthetic organism 12. The precise function of the apertures 11 varies in different types of construction, for example as follows.

In constructions where the photosynthetic organism 12 is supported outside the support layer 10 (or more generally on a side opposite from the irrigation pipe 16), for example the tubular construction of the first type, then the apertures 11 have the function of allowing passage of sufficient water therethrough to support the growth of the photosynthetic organism 12. In this case, the apertures 11 formed in the support layer 10 may in general be of any size and density that permits such passage of water, including a size that prevents the one or more photosynthetic organism 12 from penetrating the apertures 11, or a size that allows the one or more photosynthetic organism 12 to penetrate the apertures 11.

In constructions where the photosynthetic organism 12 is supported inside the support layer 10, for example the tubular construction of the third type, then the apertures 11 have the function of allowing passage of sufficient light therethrough to support the growth of the photosynthetic organism 12. Accordingly, the apertures 11 formed in the support layer 10 may in general be of any size and density that permits such passage of light, including a size that prevents the one or more photosynthetic organism 12 from penetrating the apertures 11, or a size that allows the one or more photosynthetic organism 12 penetrate the apertures 11.

In constructions where the photosynthetic organism 12 penetrates the support layer 10, for example the tubular construction of the second or fourth types, then the apertures 11 have sufficient size to achieve this, which depends on the nature of the photosynthetic organism 12. In this case, water and nutrients to support the growth of the photosynthetic organism 12 may be passed between parts of the photosynthetic organism 12 on either side of the support layer 10 by internal transport within the photosynthetic organism 12. Such internal transport may meet all the growth needs of the photosynthetic organism 12, or the apertures 11 may retain the function of allowing passage of some of the water or light needed to support the growth of the photosynthetic organism 12 externally of the photosynthetic organism 12 itself.

To provide the apertures 11, the support layer 10 may be a mesh, for example a woven mesh or a solid mesh. FIG. 9 illustrates an example of the support layer 10 that is a woven mesh, in which apertures 11 in the mesh are visible. In one example, the mesh may be stainless steel grade SS304.

The support layer 10 may be formed of any suitable material. As the support layer 10 is in a wet environment, the material is chosen so that the support layer 10 has sufficient rigidity when wet to maintain its shape. Similarly, the material is chosen to resist corrosion in the wet environment.

In one type of example, the support layer 10 is made of metal, for example stainless steel. Use of a metal provides advantageous structural properties and allows the support layer 10 to be re-used after the one or more photosynthetic organism 12 has been harvested.

In another type of example, the support layer 10 is made of a compostable material. In this case, the support layer 10 may be removed with the one or more photosynthetic organism 12 when it is harvested.

However, the tubular form of the support layer 10 is not essential. As one alternative, the support layer 10 may be curved around the irrigation pipe 16, but extending only partway around the irrigation pipe 16. In this alternative a similar irrigation advantage is achieved. As another alternative, the support layer 10 may be planar (for example as shown in FIGS. 12 and 13 and described below). In this case, irrigation may still be provided by a single irrigation pipe 16 provided that the width of support layer 10 is sufficiently small, or plural irrigation pipes 16 may be provided.

Thus, the irrigation pipe 16 forms an irrigation system for irrigating the carbon sequestration unit 1. As an alternative, an irrigation system of any other form may be provided. As another alternative, water may be supplied to the one or more photosynthetic organism 12 by exposing the carbon sequestration unit 1 to natural precipitation.

FIG. 10 shows an example of the carbon sequestration unit 1 shown in any of FIGS. 1 to 8 in which the support layer 10, and hence the carbon sequestration unit 1 as a whole, has a helical shape along its length. For clarity, FIG. 10 illustrates the support layer 10 in isolation, but the other elements shown in FIGS. 1 to 8 are present in use. In this example the helical shape is a regular helical shape, but irregular shapes (for example with varying coil pitch or diameter) may be used to provide similar advantages.

An advantage of the helical shape shown in FIG. 10 is to provide growth surface maximisation, that is maximisation of the surface area of the support layer 10, and hence the photosynthetic organism 12 supported thereby, relative to a given overall volume of the carbon sequestration unit 1 or relative to a given area of land on which the carbon sequestration unit 1 is deployed. Such a helical geometry is a particularly convenient way of providing a shape that is convoluted in three dimensions to achieve such growth surface maximisation, in a similar manner to the use of helical geometries in helical coil heat exchangers (HCHE) for use in process industries like manufacturing plants, nuclear power plants and in other commercial and domestic settings generally for heating and cooling to enhance the heat transfer coefficient. The structure is incredibly efficient as it allows for a large heat exchange surface to be accommodated in a small space. A specific example is given below.

The helical shape of the support layer 10 may be chosen to optimise the growth of the one or more photosynthetic organism 12, having regard to factors including: accommodation of the one or more photosynthetic organism 12 between the coils of the support layer 10; supply of water to the one or more photosynthetic organism 12, whether by the irrigation pipe 16, an alternative irrigation system or natural precipitation; and supply of light to the one or more photosynthetic organism 12. Thus, the precise form of the helical shape may depend on the nature of the one or more photosynthetic organism 12. However, in one illustrative example, dimensions are as follows, making reference to FIG. 11, which shows the dimensional characteristics to which reference is made. In this example:
The diameter Dw of the support layer 10 across its tubular shape is 10 mm.
The dimeter of the irrigation pipe is 3 mm.
The spacing between adjacent coils of the support layer 10 is 10 mm
The diameter of the coils 2Dw perpendicular to the helical axis A is 100 mm.
The height of the support layer projected along the helical axis A is 1 m.

However, such a helical geometry is not limitative. Alternatively, the support layer 10 and hence the carbon sequestration unit 1 as a whole may have alternative shapes along their length. In some examples, that shape may be a different shape that is convoluted in three dimensions. In other examples, that shape may be linear (i.e. as shown in FIG. 1, 3, 5 or 7 but extended in length), in which case plural carbon sequestration units 1 may be packed together in parallel.

While the tubular constructions of the carbon sequestration unit 1 are advantageous for the reasons given above, it is not essential for the carbon sequestration unit 1 to have a tubular construction. An alternative example in which the carbon sequestration unit 1 has a planar construction is shown in FIGS. 12 and 13. The cross-sections in FIGS. 12 and 13 showing the internal construction of a portion of the carbon sequestration unit 1 that is restricted in both dimensions. The carbon sequestration unit 1 may have any length along the dimension shown in FIG. 12 and any width along the dimension shown in FIG. 13, and might not be elongate.

As shown in FIGS. 12 and 12, the carbon sequestration unit 1 including a support layer 10, a growth substrate 14 and one or more photosynthetic organism 12, each of which is arranged as described above, except that they each have a planar construction. Apart from that planar construction, the support layer 10, a growth substrate 14 and one or more photosynthetic organism 12 have the same arrangement so the above description applies, except for the following differences.

In the example of FIGS. 12 and 13, the support layer 10 has a planar form in which the one or more photosynthetic organism 12 is supported on one side of the support layer 10 and plural irrigation pipes 16 are provided on the opposite side of the support layer 10. Although the carbon sequestration unit 1 is shown as flat in FIGS. 12 and 13 for clarity, in some examples the carbon sequestration unit 1 may have a shape that is convoluted in three dimensions, as described further below.

In this example, plural irrigation pipes 16 act as the irrigation system. The irrigation pipes 16 are dispersed across the width of the carbon sequestration unit 1 along the dimension shown in FIG. 13 for supplying water to the one or more photosynthetic organism 12 across that width. Although three irrigation pipes are shown in FIG. 13 for illustrative purposes, this is not limitative and in general any number of one or more irrigation pipes 16 may be used depending on the magnitude of the width. The or each individual irrigation pipe 16 has the same construction as in the examples of FIGS. 1 to 8 and so the above description thereof applies. As an alternative to the plural irrigation pipes 16, an irrigation system of any other form may be provided. As another alternative, water may be supplied to the one or more photosynthetic organism 12 by exposing the carbon sequestration unit 1 to natural precipitation.

FIG. 14 shows an example of the carbon sequestration unit 1 shown in FIGS. 12 and 13 in which the support layer 10, and hence the carbon sequestration unit 1 as a whole, has an undulating shape along its length. For clarity, FIG. 14 illustrates the support layer 10 in isolation, but the other elements shown in FIGS. 1 to 8 are present in use.

As a result of the undulating shape, when the carbon sequestration unit 1 is arranged extending across a plane 20, then the surface area of the support layer 10 and hence the photosynthetic organism 12 supported thereby is greater than the projected area onto the plane 20. In this manner, the surface area is maximised relative to a given area of land on which the carbon sequestration unit 1 is deployed.

Although FIG. 14 shows a particular example of undulating shape along the length of the carbon sequestration unit 1, other undulating shapes may be selected and the undulating shape may be applied along one or both of the length and width.

The examples of the carbon sequestration unit 1 shown in FIGS. 10 and 14 are examples in which the support layer 10 has a shape that is convoluted in three dimensions, but are not limitative and the support layer 10 may have another shape that is convoluted in three dimensions.

FIGS. 15 to 21 each show a carbon sequestration device 40 formed by an arrangement of plural carbon sequestration modules 30 that are themselves each formed by an array of plural carbon sequestration units 1 of the type shown in FIG. 10.

First, the carbon sequestration modules 30 will be described.

As best seen in FIG. 15, carbon sequestration modules 30 comprises an array of carbon sequestration units 1 arranged with the helical axes of the helical shapes of the carbon sequestration units 1 arrayed to extend in a common plane. In the example of FIG. 15, the carbon sequestration units 1 are identical and arrayed in a regular rectangular array with parallel helical axes.

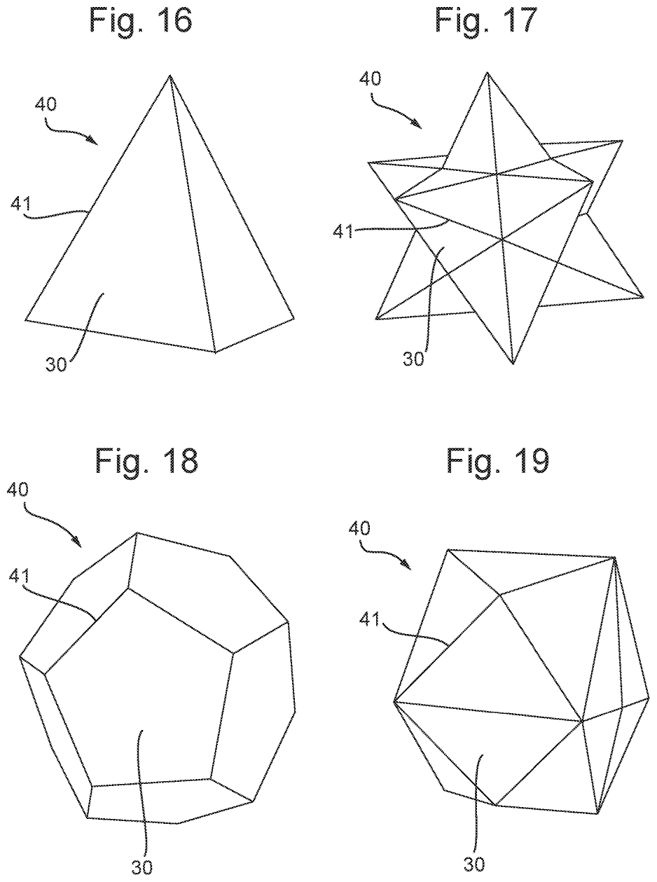

As a result, each carbon sequestration module 30 forms a panel. In the examples of FIGS. 15, 20 and 21, each carbon sequestration module 30 forms a panel in a shape that is square. In the examples of FIGS. 16, 17 and 19, each carbon sequestration module 30 forms a panel in a shape that is triangular. In the example of FIG. 18, each carbon sequestration module 30 forms a panel in a shape that is pentagonal. In general, the carbon sequestration modules 30 may form a panel in any shape, and the carbon sequestration units 1 do not need to be identical.

Next, the carbon sequestration devices 40 will be described.

In each example, the carbon sequestration devices 40 is formed by connecting plural carbon sequestration modules 30 together.

In each of the examples of FIGS. 15 to 20, the carbon sequestration devices 40 is formed by arranging the carbon sequestration modules 30 to form faces of a polyhedron. This is achieved by fixing the carbon sequestration modules 30 to a frame 41 having the shape of the edges of the polyhedron.

In the example of FIG. 15, the polyhedron is a cube.

In the example of FIG. 16, the polyhedron is a tetrahedron,

In the example of FIG. 17, the polyhedron is a star polyhedron.

In the example of FIG. 18, the polyhedron is a dodecahedron.

In the example of FIG. 19, the polyhedron is a cuboctrahedron.

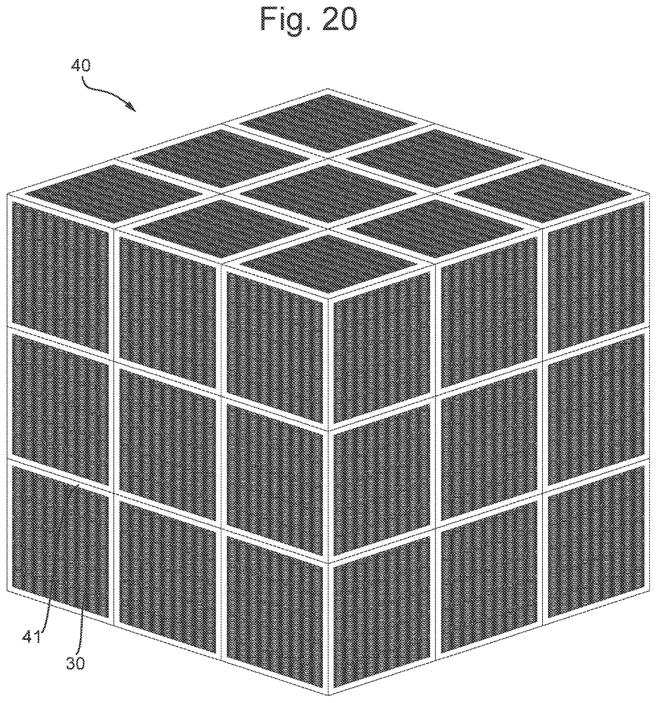

In the example of FIG. 20, the polyhedron is 3 by 3 by 3 array of cubes as a unit shape, so may be considered to be an array of 27 cubes as shown in FIG. 14 with a single carbon sequestration module 30 forming each shared internal face. Similar arrangements may be formed based on unit shapes other than a cube and with any number of unit shapes.

In general, the carbon sequestration modules 30 may form faces of any polyhedron.

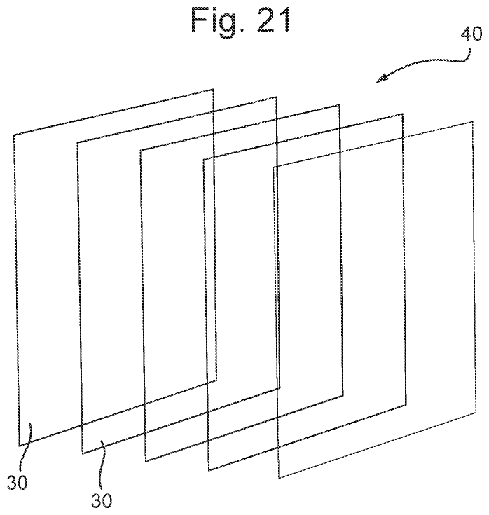

In contrast to the examples of FIGS. 15 to 20 that are based on polyhedrons, in the example of FIG. 21, the carbon sequestration devices 40 is formed by arranging the carbon sequestration modules 30 in a stack, with the carbon sequestration modules 30 parallel to each other.

The examples of FIGS. 15 to 20 are not limitative and in general the carbon sequestration modules 30 may form faces of any polyhedron.

Such arrangements of the carbon sequestration device 40 permit growth surface maximisation, that is maximisation of the total surface area of the individual support layers 10 within the carbon sequestration device 40, and hence the photosynthetic organism 12 supported thereby, relative to a given area of land on which the carbon sequestration device 40 is deployed. This effectively overcomes the limiting physical constraint of available space by densifying the photosynthetic organism 12, leading to a material multiplication factor of the carbon sequestration.

In addition, in the examples of FIGS. 15 to 20 the arrangement of carbon sequestration modules 30 forming faces of a polyhedron provides a space within the polyhedron which permits aeration of the one or more photosynthetic organism 12.

FIGS. 22 to 25 show in different views an alternative carbon sequestration module 50 formed by an array of carbon sequestration units 1 as shown in FIG. 4. In the array, the carbon sequestration units 1 are arranged with the helical axes of the helical shapes of the carbon sequestration units 1 arrayed in two dimensions orthogonal to the helical axes so that the carbon sequestration module is in the shape of a block. FIGS. 22, 24 and 25 show the actual array of carbon sequestration units 1, whereas FIG. 23 shows the overall shape of the block, omitting the individual carbon sequestration units 1 for clarity.

In the example of FIGS. 22 to 25, the carbon sequestration units 1 are identical and arrayed in a regular square array with parallel helical axes so that the carbon sequestration module 50 forms a block in a shape that is square. This is an advantage because it is an example of a shape that tessellates in three dimensions, allowing the carbon sequestration modules 50 to be tessellated so as to fully fill a given volume. However, this configuration is not essential and in general may be varied for example as follows. There may be any number of the carbon sequestration units 1 in the carbon sequestration module 50. The carbon sequestration units 1 do not need to be identical. The carbon sequestration module 50 may form a block in a different shape that tessellates, or in a shape that does not tessellate at all.

FIG. 26 shows a carbon sequestration device 60 formed by an arrangement of eight carbon sequestration modules 50 as shown in FIGS. 22 to 25. The carbon sequestration modules 50 are tessellated in a 2 by 2 array so that they fully fill a volume that is cubic in this example. This example is not limitative and in general the carbon sequestration modules 50 may have other shapes that tessellate and there may be any number of carbon sequestration modules 50.

Similar to the arrangements of the carbon sequestration device 40 shown in FIGS. 15 to 21, the arrangement of the carbon sequestration module 50 of FIGS. 22 to 25 permits growth surface maximisation, that is maximisation of the total surface area of the individual support layers 10 within the carbon sequestration device 40, and hence the photosynthetic organism 12 supported thereby, relative to a given area of land on which the carbon sequestration device 40 is deployed. This effectively overcomes the limiting physical constraint of available space by densifying the photosynthetic organism 12, leading to a material multiplication factor of the carbon sequestration.

In other alternatives, a carbon sequestration device may similarly be formed by an arrangement of both carbon sequestration module 30 that form a panel and carbon sequestration modules 50 that form a block.

The examples above provide growth surface maximisation in various ways. To illustrate typical multiplication factors that may be achieved, the illustrative example of the carbon sequestration unit 1 given above with reference to FIG. 11 is considered as follows.

In this carbon sequestration unit 1, the number of turns N in the helical shape is given by N=H/(Dw+S) such that N=50.

The length L of the helical shape is given by L=π.Dc.N so that L=15,708 mm.

The surface area SA of the support layer is given by SA=2πr L so that SA=493,482.5 mm² or 0.4935 m².

Compared to a hollow tube of diameter Dw=10 mm and height H=1,000 mm providing a growth surface of 32×10⁻³ m², such a growth surface of 49×10⁻² m² provides a multiplication factor of 15.

In a carbon sequestration module 50 of the type shown in FIGS. 22 to 25, an array of 95 carbon sequestration units 1 would fit into a cubic volume of 1 m³ giving a total growth surface of 46.8 m² per m³ and a total 94 kg of CO₂ sequestration per annum. That is approximately the equivalent of 4 fully grown-up trees (depending of course on the type of tree). Such factors may be achieved for all shapes considering a constant volume.

Working such factors through, 5×10¹¹ m² of coverage would be required to sequester 1 GtC. Scaling up to allow for the volume of CO₂ emissions being emitted into the atmosphere gives 33 (5×10¹¹) m²=165×10¹¹ m². Dividing this surface area by 46.88 m² leaves approximately 352×109 m². Taking a square root of this, the above 1 m³ modules would consecutively fill a land space of 593 km×593 km to sequester approximately the amount of CO₂ being emitted by human-driven industrial activities annually.

By stacking such carbon sequestration modules 50 vertically, the land space required decreases dramatically. Picking an arbitrary figure of a height of 100 m, which is not much higher than an average domed stadium, the total land area would reduce to a structure that is 59.3 km×59.3 km, or approximately 35×10² km².

FIG. 27 illustrates a method of using the carbon sequestration units, modules or devices described herein and is performed as follows.

In step S1, one or more photosynthetic organism 12 is grown on the carbon sequestration unit, module or device. In this manner, CO₂ is captured from the atmosphere and converted into carbon-containing matter of the growing one or more photosynthetic organism 12.

In step S2, the one or more photosynthetic organism 12 is harvested. This allows the harvested organism to be stored or used without releasing CO₂ back into the atmosphere. This may involve removing the one or more photosynthetic organism 12 from the support layer 10, allowing the support layer 10 to be re-used. Alternatively, this may involve removing the entire support layer 10 with the one or more photosynthetic organism 12.

In step S3, the harvested organism is buried or is pyrolysed to produce a product for disposal or use. In this manner, the stored carbon is prevented from being returned to the atmosphere.

In the case of burial, where the support layer 10 is formed from a decomposable material and harvesting is performed by removing the entire support layer 10 with the one or more photosynthetic organism 12, then the support layer 10 may be buried with the one or more photosynthetic organism 12.

In the case of pyrolysis, it is possible to produce a product that may have a useful purpose in industry or manufacture.

In general, the one or more photosynthetic organism 12 may be any suitable photosynthetic organism. It may be a single photosynthetic organism or plural different ones. Some non-limitative examples are given below.

The one or more photosynthetic organism 12 may be from the division Chlorophyta. In this case, the photosynthetic organism 12 may be one or more of Chlorella sp., Chlamydomonas sp., or Chlorococcum sp.

The one or more photosynthetic organism 12 may be from the division Bryophyta. In this case, the photosynthetic organism 12 may be one or more of a liverwort, a hornwort, or a moss.

In the case of a liverwort, the liverwort may be Marchantia polymorpha.

In the case of a hornwort, the hornwort may be Phaeoceros laevis.

In the case of a moss, the moss may be Hylocomium splendens, Hypnum cupressiforme, Dicranella heteromalla, Sphagnum fuscum or Polytrichum commune.

In the case of a photosynthetic organism 12 from the division Bryophyta, the photosynthetic organism 12 may have a foliose or thalloid growth habit.

The one or more photosynthetic organism 12 may be from the division Pteridophyta. In this case, the photosynthetic organism 12 may be one or more of a fern or horsetail.

In the case of a fern, the fern may be Asplenium sp. or Polypodium sp.

The one or more photosynthetic organism 12 may be from the division Magnoliophyta. In this case, the photosynthetic organism 12 may be one or more of a monocot or a dicot.

In the case of a dicot, the dicot may be Sedum sp. or Thymus sp.

In the case of a photosynthetic organism 12 from the division Pteridophyta or Magnoliophyta, the photosynthetic organism may have a prostrate or procumbent growth habit.

1. A carbon sequestration unit comprising:
a support layer configured to support one or more photosynthetic organism.

2. The carbon sequestration unit according to claim 1, wherein the support layer has apertures.

3. The carbon sequestration unit according to claim 2, wherein the support layer is a mesh, optionally a woven mesh.

4. The carbon sequestration unit according to claim 1, wherein the support layer is a sheet.

5. The carbon sequestration unit according to claim 1, further comprising:
an irrigation pipe configured to release water along its length for irrigating the one or more photosynthetic organism, the irrigation pipe extending along the support layer.

6. The carbon sequestration unit according to claim 5, wherein the irrigation pipe is anchored to the support layer.

7. The carbon sequestration unit according to claim 5, wherein the support layer is curved and extends at least partly around the irrigation pipe.

8. The carbon sequestration unit according to claim 5, wherein the support layer has a tubular form and extends around the irrigation pipe.

9. The carbon sequestration unit according to claim 5, wherein the support layer has apertures and is configured to support the one or more photosynthetic organism on a side opposite from the irrigation pipe, and the apertures are configured to allow the passage of water from the irrigation pipe to the one or more photosynthetic organism.

10. The carbon sequestration unit according to claim 5, wherein the support layer has apertures and is configured to support the one or more photosynthetic organism on the same side as the irrigation pipe, and the apertures are configured to allow the passage of light to the one or more photosynthetic organism.

11. The carbon sequestration unit according to claim 5, wherein the support layer has apertures that are configured to allow the one or more photosynthetic organism to penetrate the support layer such that the support layer is configured to support the one or more photosynthetic organism on both sides thereof.

12. The carbon sequestration unit according to claim 1, wherein the support layer has a shape that is convoluted in three dimensions.

13. The carbon sequestration unit according to claim 12, wherein the support layer is elongate.

14. The carbon sequestration unit according to claim 12, wherein the support layer has a tubular form and is elongate along a tubular axis thereof.

15. The carbon sequestration unit according to claim 13, wherein the support layer has a shape along its length that is convoluted in three dimensions.

16. The carbon sequestration unit according to claim 15, wherein the shape is a helical shape, optionally a regular helical shape.

17. The carbon sequestration unit according to claim 12, wherein the support layer has an undulating shape so that its surface area is greater than a projected area onto a plane across which the support layer extends.

18. The carbon sequestration unit according to claim 1, wherein the support layer has sufficient rigidity when wet to maintain its shape.

19. The carbon sequestration unit according to claim 1, wherein the support layer is made of metal or is made of a compostable material.

20. The carbon sequestration unit according to claim 1, further comprising a growth substrate for the one or more photosynthetic organism disposed along the support layer.

21. The carbon sequestration unit according to claim 1, further comprising one or more photosynthetic organism supported on the support layer.

22. The carbon sequestration unit according to claim 21, wherein the photosynthetic organism is from the division Chlorophyta, Bryophyta, Pteridophyta, or Magnoliophyta.

23. The carbon sequestration unit according to claim 22, wherein the photosynthetic organism from the division Chlorophyta is Chlorella sp., Chlamydomonas sp., or Chlorococcum sp.

24. The carbon sequestration unit according to claim 22, wherein the photosynthetic organism from the division Bryophyta is a liverwort, a hornwort, or a moss; optionally wherein the photosynthetic organism has a foliose or thalloid growth habit; further optionally wherein:
(i) the liverwort is Marchantia polymorpha;
(ii) the hornwort is Phaeoceros laevis, or
(iii) the moss is Hylocomium splendens, Hypnum cupressiforme, Dicranella heteromalla, Sphagnum fuscum or Polytrichum commune.

25. The carbon sequestration unit according to claim 22, wherein the photosynthetic organism from the division Pteridophyta is a fern or horsetail; optionally wherein the fern is Asplenium sp. or Polypodium sp.

26. The carbon sequestration unit according to claim 22, wherein the photosynthetic organism from the division Magnoliophyta is a monocot or a dicot; optionally wherein the dicot is Sedum sp. or Thymus sp.

27. The carbon sequestration unit according to claim 25, wherein the photosynthetic organism has a prostrate or procumbent growth habit.

28. A carbon sequestration module comprising plural carbon sequestration units according to claim 1.

29. The carbon sequestration module according to claim 28, wherein:
in the carbon sequestration units, the support layer is elongate and has a helical shape along its length; and
the carbon sequestration units are arranged with helical axes of the helical shapes arrayed to extend in a common plane so that the carbon sequestration module forms a panel.

30. The carbon sequestration module according to claim 28, wherein:
in the carbon sequestration units, the support layer is elongate and has a helical shape along its length; and
the carbon sequestration units are arranged with the helical axes of the helical shapes arrayed in two dimensions orthogonal to the helical axes so that the carbon sequestration module forms a block.

31. The carbon sequestration module according to claim 28, wherein the carbon sequestration module has a shape that tessellates.

32. A carbon sequestration device comprising plural carbon sequestration modules according to claim 28.

33. The carbon sequestration device according to claim 32, wherein the carbon sequestration modules comprise plural carbon sequestration units, each carbon sequestration unit comprising the support layer configured to support one or more photosynthetic organism, and
wherein in the carbon sequestration units, the support layer is elongate and has a helical shape along its length, and the carbon sequestration units are arranged with helical axes of the helical shapes arrayed to extend in a common plane so that the carbon sequestration module forms a panel,
and the carbon sequestration modules are arranged to form faces of a polyhedron.

34. The carbon sequestration device according to claim 32, wherein the carbon sequestration modules comprise plural carbon sequestration units, each carbon sequestration unit comprising the support layer configured to support one or more photosynthetic organism, and the carbon sequestration modules are tessellated.

35. A method of sequestering carbon comprising growing one or more photosynthetic organism on a carbon sequestration unit comprising a support layer configured to support one or more photosynthetic organism, on a carbon sequestration module comprising plural carbon sequestration units, each carbon sequestration unit comprising a support layer configured to support one or more photosynthetic organism, or on a carbon sequestration device according to claim 32.

36. The method according to claim 35, further comprising harvesting the organism.

37. The method according to claim 36, further comprising burying the harvested organism or pyrolysing the harvested organism to produce a product for disposal or use.
